(19) United States
(12) Patent Application Publication
(10) Pub. No.: US 2023/0061545 A1
(43) Pub. Date: Mar. 2, 2023

(54) FASTENER PIN

(71) Applicant: Illinois Tool Works Inc., Glenview, IL (US)

(72) Inventors: Tayebeh Alirezaee, Melbourne (AU); David Collinson, Melbourne (AU)

(21) Appl. No.: 17/894,422

(22) Filed: Aug. 24, 2022

(30) Foreign Application Priority Data
Aug. 25, 2021 (AU) 2021232748

(51) Int. Cl. F16B 19/00

(52) U.S. Cl. CPC F16B 19/00

(57) ABSTRACT

A steel fastener having an elongate shank, an enlarged head formed at one end of the shank, and a generally pointed tip formed at the other end of the shank, the shank having a knurled portion formed with helical grooves defining helical ribs and with annular grooves defining annular rings, wherein the knurled portion extends up the shaft to adjacent an underside of the head.

### PRIORITY CLAIM

The present application claims priority to and the benefit of Australian Patent Application No. 2021232748, filed Aug. 25, 2021, the entire contents of which are incorporated herein by reference.

### FIELD

The present disclosure relates to a steel fastener having a having a grooved shaft configured for metal-to-metal connections.

### BACKGROUND

A useful form of fastener primarily for fastening a workpiece having a given thickness to a metal substrate having a thinner wall, and secondarily for fastening such a workpiece to a wooden substrate, is described in U.S. Pat. No. 5,741,104.

Embodiments of the present disclosure seek to provide a fastener with improved performance for metal-to-metal connections.

### SUMMARY

In accordance with the present disclosure there is provided a steel fastener having an elongate shank, an enlarged head formed at one end of the shank, and a generally pointed tip formed at an opposite end of the shank. The shank includes a knurled portion formed with helical grooves defining helical ribs and with annular grooves defining annular rings, wherein the knurled portion extends up the shaft to adjacent an underside of the head.

In one form of the present disclosure, the knurled portion extends down the shaft to the beginning of the tapering pointed tip.

In embodiments of the present disclosure, the tip includes a point geometry having a generally parabolic profile.

Further features of embodiments of the present disclosure will be apparent from the description that follows.

### BRIEF DESCRIPTION OF THE DRAWINGS

Embodiments are described in further detail below, by way of example, with reference to the accompanying drawings, in which:

FIG. 1 is a side view of a fastener according to one example embodiment of the present disclosure;

FIG. 2 is an end view of the fastener of FIG. 1;

FIG. 3 shows a cross section through a fastener according to one embodiment of the present disclosure inserted through a metal fastening substrate; and

FIGS. 4 and 5 are a side and end views, respectively, of a fastener according to another embodiment of the present disclosure.

### DETAILED DESCRIPTION

While the features, devices, and apparatus described herein may be embodied in various forms, the drawings show and the specification describe certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, attached, connected, and the like, are not intended to be limited to direct mounting methods but should be interpreted broadly to include indirect and operably mounted, attached, connected and like mounting methods. This specification is intended to be taken as a whole and interpreted in accordance with the principles of the present disclosure and as understood by one of ordinary skill in the art.

The fastener described in the specification of U.S. Pat. No. 5,741,104, the contents of which are incorporated herein by reference, is configured primarily for fastening a workpiece having a given thickness to a metal substrate having a thinner wall. While the performance fastening performance in its intended application is without fault, there have been found to be limitations when applying such a fastener in thin metal to metal connections.

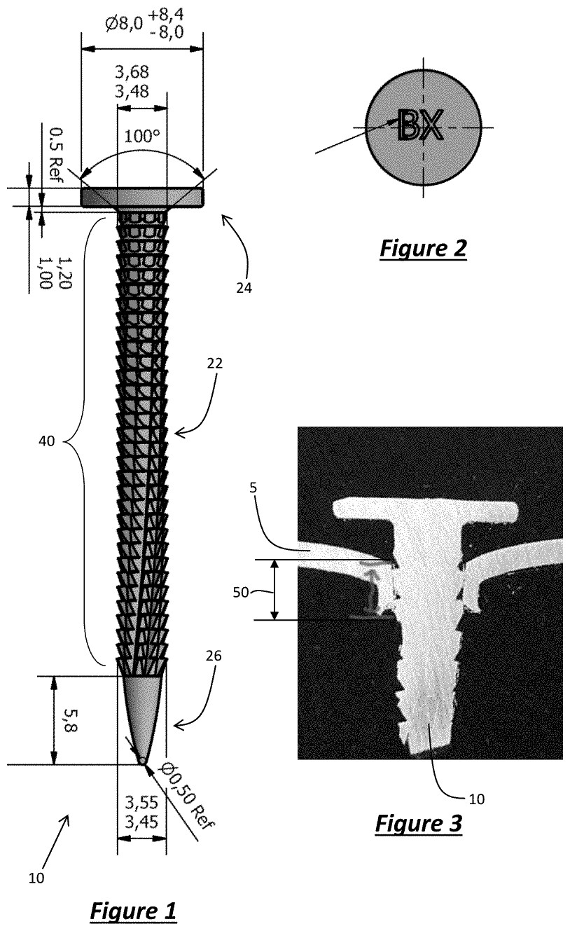

A fastener pin 10 according to an embodiment of the present disclosure is disclosed herein having features configured to overcome or reduce the limitations of this known fastener. The fastener pin 10 is shown in FIG. 1 includes an elongate shank 22 defining an axis, an enlarged head 24 formed at one end of the shank 22, and a generally pointed tip 26 formed at the other opposite end of the shank 22. In this example embodiment, as shown, the tip 26 is bullet shape or has parabolic point profile. The whole fastener pin shaft is made with a taper, making sure the tip end is thinner and it progressively gets slightly larger to the head end. In the example dimensions seen in the Figures, the shaft as a diameter of (3.68-3.48) mm closer to head compared to (3.55-3.45) mm closer to tip.

The shank 22 has a knurled portion 40 formed with a series of annular grooves, which define a series of annular rings, and with a circumferential array of helical grooves, which define a circumferential array of helical ribs. In contrast to the previously known fastener, the knurled section 40 of the shank on fastener pin 10 extends largely the full length of the shaft, from just below where the shank 22 meets the head 24 (0.5 mm gap) up to where the tapering of the tip 26 begins. The addition of knurling near the tip and particularly close to the fastener head provides improved holding power when the fastener pin 10 is in use and enables the fastener pin 10 to more effectively accommodate connections between thinner metal sections. Moreover, the head 24 has a flat underside where the head meets the shaft 22, with only minimal corner relief at the junction.

This contrasts with the known fastener configuration in U.S. Pat. No. 5,741,104 which has a smooth cylindrical portion between the ringed portion 40 and the head 24, a smooth cylindrical portion between the ringed portion 40 and the tip 26, and a pronounced chamfer where the head 24 faces the shank 22. Where the known fastener configuration had some limitations with thin metal performance, the fastener pin 10 according to embodiments of the present disclosure is able to overcome this shortcoming. Referring to FIG. 3, features of the fastener pin 10 in use produces an increased length of metal, indicated at reference numeral 50, for the knurling of the fastener shaft to grab onto. More particularly, FIG. 3 shows where an example of the fastener pin 10 has been driven through a thin metal sheet material 5, in the process deforming the edges of the hole in the metal sheet and thereby increasing the surface area for knurling on the pin shaft to grip with. The parabolic point shape gives better metal flow that increases the surface area of contact between the pin and the substrate.

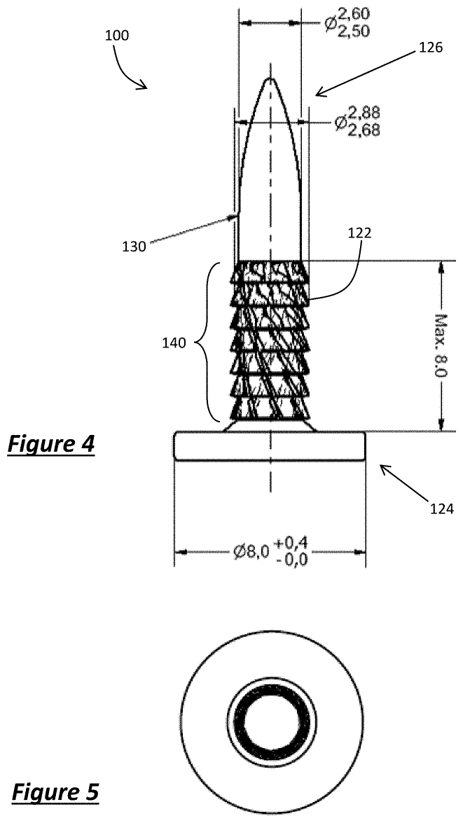

FIGS. 4 and 5 illustrate a fastener pin 100 according to another embodiment of the present disclosure. The fastener pin 100 has a generally similar configuration as fastener pin 10 but is shorter in length in view of its intended application for fastening relatively thin materials. The fastener pin 100 has a flat head 124 at one end of a shaft 122, with knurling 140 on the shaft beginning next to the underside of the head. A pointed tip 126 is at the other end of the shaft, with a smooth section of the shaft between the end of knurled section 140 and the start of the tip. The shape of the tip 126 in this case has a bullet like point, close to parabolic in the point profile. The rounded bullet shaped or parabolic profile point on the fastener pins according to embodiments of the present disclosure provides advantageous results when the fastener is applied, as compared to a point having a frusto-conical or truncated cone shape.

Embodiments have been described herein by way of example, with reference to various possible features and functions. Such embodiments are intended to be illustrative rather than restrictive. It should be understood that embodiments include various combinations and sub-combinations of features described herein, even if such features are not explicitly described in such a combination or sub-combination.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

1. A steel fastener comprising:
an elongate shank including a knurled portion formed with helical grooves defining helical ribs and with annular grooves defining annular rings;
an enlarged head at one end of the shank; and
a tip at an opposite end of the shank,
wherein the knurled portion extends up the shaft to adjacent an underside of the head.

2. The fastener of claim 1, wherein the knurled portion extends down the shaft to a beginning portion of the tip.

3. The fastener of claim 2, wherein the tip is a tapered pointed tip.

4. The fastener of claim 3, wherein the tip has a generally parabolic profile.

5. The fastener of claim 1, wherein the tip is a tapered pointed tip.

6. The fastener of claim 5, wherein the tip has a generally parabolic profile.

7. The fastener of claim 1, wherein the tip has a generally parabolic profile and wherein the knurled portion extends down the shaft to a beginning of the tip.

8. The fastener of claim 1, wherein the tip has a generally parabolic profile.
